(19) United States
(12) Patent Application Publication
(10) Pub. No.: US 2022/0150566 A1
(43) Pub. Date: May 12, 2022

(54) Video Display System

(71) Applicant: Telstar USA LLC, Eden Prairie, MN (US)

(72) Inventors: Richard Erickson, Hopkins, MN (US); Jacob Maas, Bloomington, MN (US); Reza Aghelnejad, Minneapolis, MN (US)

(21) Appl. No.: 17/518,809

(22) Filed: Nov. 4, 2021

Related U.S. Application Data
(60) Provisional application No. 63/110,453, filed on Nov. 6, 2020.

(51) Int. Cl. H04N 21/41; G03B 21/14; G03B 21/54; H04W 4/80; G06F 21/31; G06F 21/84; H04L 41/0806; H04N 21/81; H04N 21/472; H04N 21/482

(52) U.S. Cl. CPC H04N 21/4122; G03B 21/14; G03B 21/54; H04W 4/80; G06F 21/31; G03B 2206/00; H04L 41/0806; H04N 21/8173; H04N 21/47202; H04N 21/4821; G06F 21/84

(57) ABSTRACT

A video display system has a computing device for running a browser, a projector including a microprocessor and the projector for transferring setup preferences and for connecting to a networking library. The browser connecting to a first video content website that receives a user's first authentication data and the browser connecting to a second video content website that receives the user's second authentication data; and the projector storing the first and second authentication data during an initial setup step. The projector receives a first video stream link from the first website and a second video stream link from the second website, without inputting additional authentication data beyond the initial setup step. A control page presents an aggregation of the first website icon and a second website icon from which the user may select video programming.

The present invention claims priority to provisional application No. 63/110,453, filed Nov. 6, 2020. The present invention pertains to a video display system and method of displaying a video stream.

### BACKGROUND

Projectors with Digital Light Processing (DLP), or LCD using LED lamp technology are used in the mobility market for projecting content for business, entertainment or education. With the advent of people sharing content, the portable projector provides a bigger screen than a smartphone. The projectors use a battery or AC adapter to power and re-charge the projector while projecting a 25″ to 120″ image on a screen, wall or other material. Since projectors are portable, content can be streamed in any environment or setting without access to an electrical outlet. Typically, a handheld device, phone, laptop, or tablet would plug in to the projector to display the content. Content may be displayed from multiple streaming services such as Apple TV+, Amazon Prime, Hulu, YouTube TV and others. Typically, using multiple streaming services, requires individual and time consuming login to each service individually, to view content and select a movie or item to project.

Video projectors, such as DLP or 1080p projectors are known for projecting images on screens (e.g. across a room). It is well known to connect such projectors to a DVD player or other device to receive a video signal. Because of the widespread use of cloud storage and streaming on demand of videos, the use of DVD players is in decline. Recent TVs have connections to streaming services. But projectors are typically less expensive than smart TVs. Thus, there is a need for a projector that can aggregate multiple streaming platforms on a single screen and use a single login process to select content for consumers to view.

### SUMMARY

The present invention provides for a video display system comprising a computing device for running a browser, a projector including a microprocessor, the browser connecting to a first video content website that receives a user's first authentication data the browser connecting to a second video content website that receives the user's second authentication data. The invention provides for the projector storing the first and second authentication data during an initial setup step, the projector receiving a first video stream link from the first video content website and a second video stream link from the second video content website without inputting additional authentication data beyond the initial setup step, a control page presents an aggregation of a first website icon, a second website icon from which the user may select video programming and the projector transmitting a selected video programming video stream.

The invention in an embodiment may provide a wireless communication connection established between the computing device and the projector for transferring setup preferences and for connecting to a networking library, and the wireless communication connection is established using Bluetooth Low Energy (BLE) protocol. The invention provides the projector including a power supply, a lens and a light source. The computing device may be integrated within the projector. In an embodiment, the computing device may be provided by a USB device that is pluggable to a USB port of the projector.

In another embodiment, the projector may use a LINUX Bluetooth protocol stack to store credentials. In an embodiment, the projector may use a Qt Network for a networking library for connecting to a network. The projector may use a modified Chromium browser to establish a Widevine security level. The control page may provide for ordering of the select video programming using one of the categories of Trending, Just Out, Your Queu and Continue Watching.

In another embodiment a method for transmitting a video stream comprises the steps of providing a projector having a microprocessor, running a browser on the microprocessor, connecting, via a browser to a first video content website that receives a user's first authentication data, connecting, via the browser to a second video content website that receives the user's second authentication data, storing the first and second authentication data during an initial setup step to the projector, receiving a first video stream link from the first video content website and a second video stream link from the second video content website, without inputting additional authentication data beyond the initial setup step for the first and second video content website, presenting on a control page an aggregation of a first website icon and a second website icon from which the user may select video programming and transmitting, via the projector a selected video programming video stream.

In an embodiment, the method further comprises the step of loading a hidden web browser on the projector to connect to each of the first and second video content web sites and wherein the projector links to many other video content websites in addition to the first and second video content web sites. The method may further comprise the step of modifying HTML and CSS using JavaScript to maintain consistent theme or styling for the hidden browser.

In an embodiment the method may further comprise the steps of embedding JavaScript code into a video content web page, decrypting streaming data from the selected video programming video stream, iterating through all document object model (DOM) elements on a video content web page, making video elements invisible using cascading style sheets (CSS), modifying the video element's CSS, so that the video elements fill an entire page and inserting user interface (UI) elements to style the DOM elements.

In a further embodiment the invention provides a system for displaying video content comprising a computing device for running a browser, software for running code, the browser connecting to a first video content website that receives a user's first authentication data, the browser connecting to a second video content website that receives a user's second authentication data, the software storing the first and second authentication data during an initial setup step, the software receiving a first video stream link from the first website and a second video stream link from the second website without inputting additional authentication data beyond the initial setup step, a control page presents an aggregation of a first website icon and a second website icon from which the user may select video programming and the software transmitting a selected video programming video stream. The software may be embedded in a microprocessor. The microprocessor may be embedded in a projector having a light source, an energy source and a lens.

In an embodiment, the computing device and software may be embedded within a projector and wherein the projector establishing a connection using a wireless communication media with the projector for transferring setup preferences and for connecting to a networking library. The computing device may include a microprocessor that runs a synchronization application for managing multiple types of video streaming platforms. The microprocessor may run iOS or Android. A hidden web browser may be provided that connects to each streaming platform's website and transmits first user authentication data to a corresponding first video content website and second user authentication data to a corresponding second video content website.

### BRIEF DESCRIPTION OF THE DRAWING FIGURES

FIG. 1 is a flow diagram of the steps involved in displaying video streams of the present invention;

FIG. 2 is a flow diagram of the further steps involved in the steps from FIG. 1, for displaying video streams of the present invention;

FIG. 3 is a tree diagram of the HTML hierarchy of a display of the present invention; and

FIG. 4 is a screen shot of a control page in an embodiment of the present invention depicting the aggregation of multiple streaming platforms.

This specification references and incorporates the above-identified Figures and describes one of more specific embodiments of the invention that are offered only to exemplify the invention and are shown and described in sufficient detail to enable those skilled in the art to implement or practice the invention.

### DETAILED DESCRIPTION

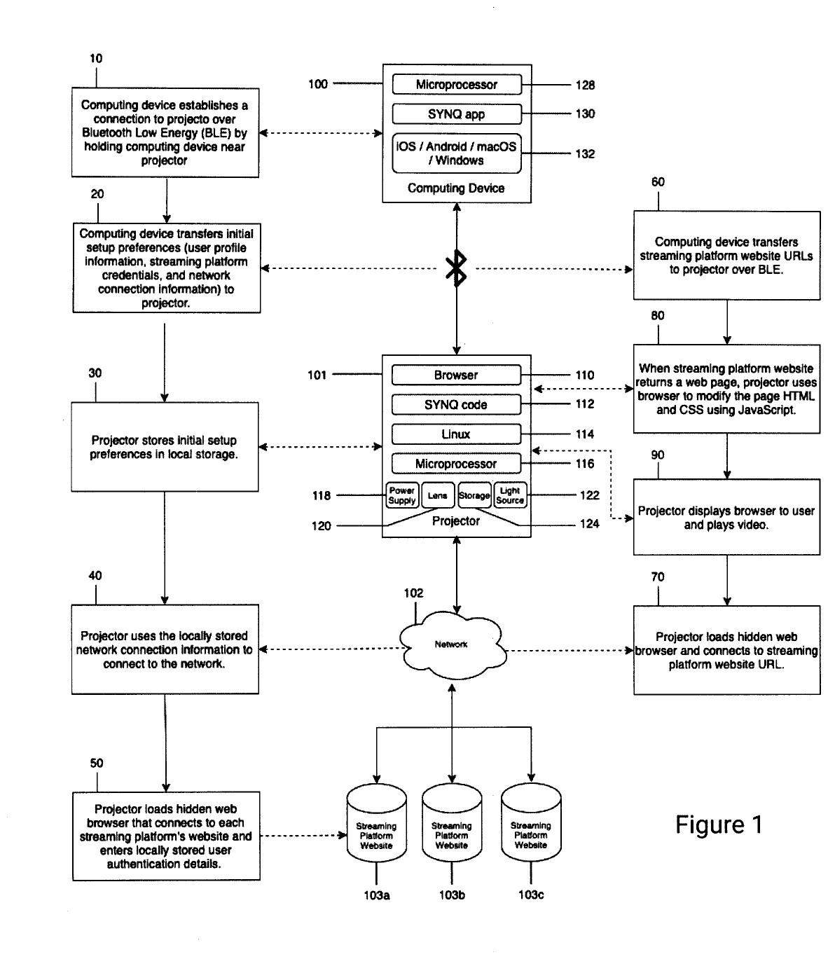

Turning to FIG. 1, step 10 begins with the computing device 100 establishing a connection to the projector 101, for example, over Bluetooth Low Energy (BLE). A wireless connection may be activated by holding the computing device 100 in close proximity (e.g. less than 5 feet) to or tapping the computing device 100 to the projector 101. In another embodiment, software on the computing device 100 may be used to locate the BLE of the projector 101 and pair the computing device 100. In an embodiment, the computing device 100 may be separate from the projector 101, such as a USB drive that is pluggable to a USB port on the projector 101; or integrated (embedded) with the projector 101. The computing device 100 includes a microprocessor 128 that runs Java code on which a synchronization (“SYNQ”) application 130 and an operating system 132 such as iOS or Android are run. The projector includes a power supply 118, a lens 120, a light source 122 and a microprocessor 116. The projector microprocessor 116 can run an internet browser 110, SYNQ code 112 and Linux kernel 114. In an embodiment, the microprocessor includes a system on chip (SOC). Using the browser 110, the projector 101 is connected to an internet network or cloud 102.

The computing device 100 uses its native BLE framework (CoreBluetooth on iOS and BluetoothManager on Android) to complete step 10 by sending streaming platform 103a-c credentials to the projector 101. The credentials may include authorization data of 1, 2, 3 or n users. The projector 101 uses BlueZ (BlueZ is the official Linux Bluetooth protocol stack and is part of the official Linux kernel) to store the credentials at step 20.

Once the connection has been established at step 10, the computing device 100 transfers the initial setup preferences (user profile information, streaming platform credentials, and network connection information) to the projector 101.

At step 30 the projector 101 stores these preferences to local storage 124. At step 40 the projector uses the locally stored network connection information to connect to the network 102 using Qt Network (the projector code base may be built using an open source framework called Qt, and Qt Network is a networking library built within this framework).

At step 50, once connected, the projector 101 loads a hidden web browser 110 that connects to each streaming platform's website 103a-c and enters the user's authentication details at step 50. There may be multiple streaming platform websites 103n that the browser 110 may connect to. The projector uses an unmodified Chromium browser (Google's open source version of Chrome) to connect to each website. In an alternative embodiment, a Chromium browser may be modified to achieve a higher Widevine security level.

Once the projector 101 is connected to the network 103 and the user is authenticated on the streaming platform websites 103a-c, the computing device 100 at step 60 may transmit streaming platform website URLs to the projector using BLE. It is to be understood that the multiple streaming platform websites 103n, having received multiple authentication data of users a-n, can stream multiple video streaming links a-n depending on the video streaming link selected by the user.

At step 70 the projector 101 loads a hidden browser and connects to the website URL. The projector 101 may use the same Chromium browser along with a Widevine CDM plugin to connect to the website and decrypt the stream data. Once the streaming platform website returns a web page, the projector 101 at step 80 uses the browser to modify the page HTML and CSS using JavaScript. These modifications are used to maintain a consistent theme and styling. After the modifications are complete, the projector 101 displays the browser to the user and plays the video at step 90.

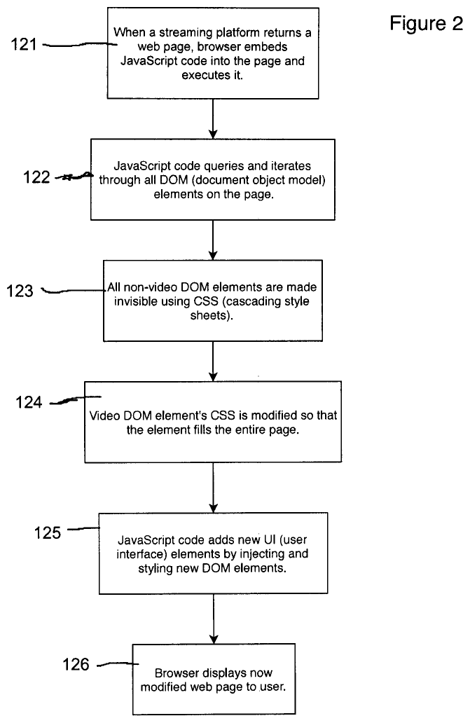

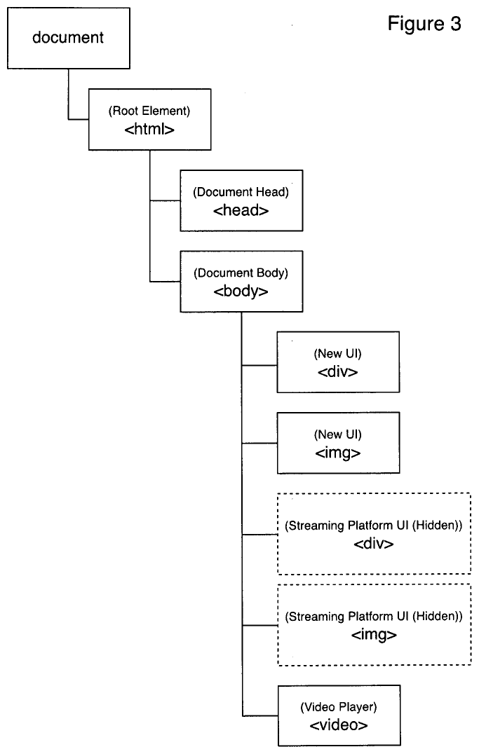

Turning to FIG. 2, the process following step 80 is further described. Once the streaming platform 103a-c returns a web page, the browser embeds JavaScript code into the page and executes it 121. This code queries and iterates through all document object model (DOM) elements on the page 122. In an embodiment, any video elements are temporarily ignored, while all other elements are made invisible using cascading style sheets (CSS) 123. In an alternative embodiment, the Z Index can be lowered, so that they are hidden behind the other elements. See FIG. 3 for sample HTML tree. The code then modifies the video element's CSS, so that the element fills the entire page 124. Lastly, the code adds new user interface (UI) elements by injecting and styling additional DOM elements 125. Once the JavaScript code finishes executing, the browser displays the now modified page to the user 126.

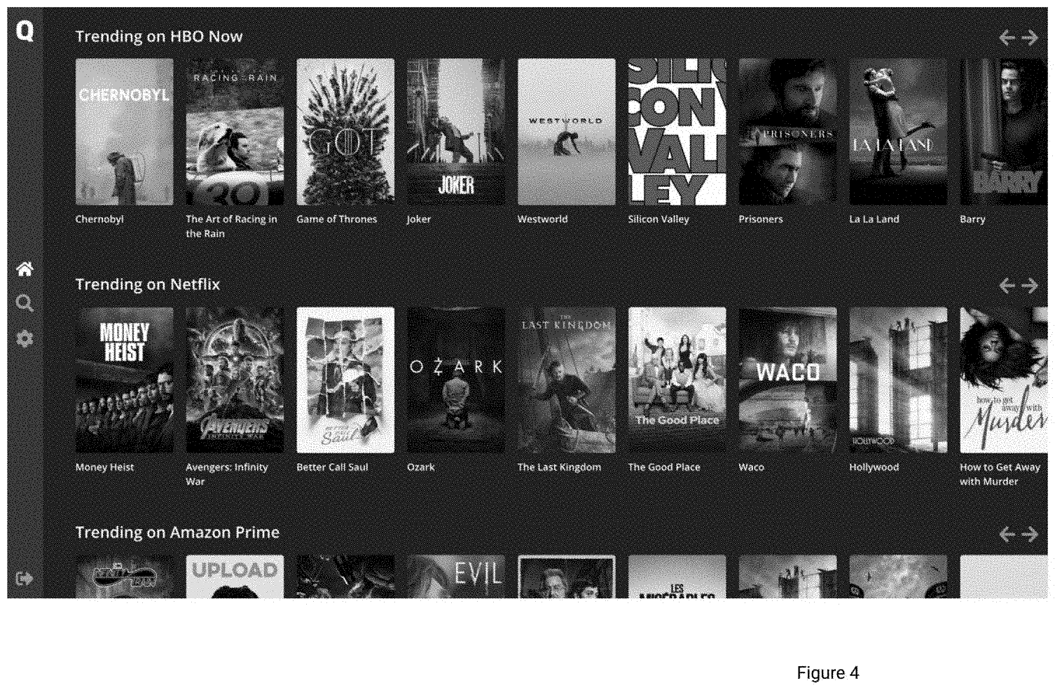

FIG. 4 depicts a screen shot of an embodiment of the opening control page of the present system. The page depicts an aggregation of streaming platforms 103a-c (in the guise of icons/graphic images/tombstones/titles of individual shows or movies) from which programming may be selected. Via the use of a hidden web browser and authentication to multiple streaming platforms simultaneously, a user may avoid repetitive login procedures and quickly select a platform 103a-c and quickly search for a program. In an embodiment, a search bar may be provided where the user may enter a search term (e.g. “Game of Thrones”) in order to quickly search across multiple platforms to find a single title or show. The user could also search for a particular season or episode. The control page may also allow for ordering of such aggregation of shows by “Trending,” “Just Out,” “Your Queu,” or “Continue Watching.”

The present invention may have many alternatives and the description above is only meant to describe the currently preferred embodiments and its full scope is to be understood to include all those embodiments known to those of ordinary skill in the art and as claimed.

What is claimed is:

1. A video display system comprising:
a computing device for running a browser;
a projector including a microprocessor;
the browser connecting to a first video content website that receives a user's first authentication data;
the browser connecting to a second video content website that receives the user's second authentication data;
the projector storing the first and second authentication data during an initial setup step;
the projector receiving a first video stream link from the first video content website and a second video stream link from the second video content website without inputting additional authentication data beyond the initial setup step;
a control page presents an aggregation of a first website icon and a second website icon from which the user may select video programming; and
the projector transmitting a selected video programming video stream.

2. The system of claim 1 wherein a wireless communication connection established between the computing device and the projector for transferring setup preferences and for connecting to a networking library, and the wireless communication connection is established using Bluetooth Low Energy (BLE) protocol.

3. The system of claim 1 wherein the projector includes a power supply, a lens and a light source.

4. The system of claim 1 wherein the computing device is integrated within the projector.

5. The system of claim 1 wherein the computing device is provided by a USB device that is pluggable to a USB port of the projector.

6. The system of claim 1 wherein the projector uses a LINUX Bluetooth protocol stack to store credentials.

7. The system of claim 1 wherein the projector uses a Qt Network for connecting to a networking library.

8. The system of claim 1 wherein the projector uses a modified Chromium browser to establish a Widevine security level.

9. The system of claim 1 wherein the control page provides for ordering of the select video programming using one of the categories of Trending, Just Out, Your Queu and Continue Watching.

10. A method for transmitting a video stream comprising the steps of:
providing a projector having a microprocessor;
running a browser on the microprocessor;
connecting, via a browser to a first video content website that receives a user's first authentication data;
connecting, via the browser to a second video content website that receives the user's second authentication data;
storing the first and second authentication data during an initial setup step to the projector;
receiving a first video stream link from the first video content website and a second video stream link from the second video content website, without inputting additional authentication data beyond the initial setup step for the first and second video content website;
presenting on a control page an aggregation of a first website icon and a second website icon from which the user may select video programming; and
transmitting, via the projector a selected video programming video stream.

11. The method of claim 10 further comprising the step of loading a hidden web browser on the projector to connect to each of the first and second video content web sites and wherein the projector links to many other video content websites in addition to the first and second video content web sites.

12. The method of claim 11 further comprising the step of modifying HTML and CSS using JavaScript to maintain consistent theme or styling for the hidden browser.

13. The method of claim 10 further comprising the steps of:
embedding JavaScript code into a video content web page;
decrypting streaming data from the selected video programming video stream;
iterating through all document object model (DOM) elements on a video content web page;
making video elements invisible using cascading style sheets (CSS);
modifying the video element's CSS, so that the video elements fill an entire page; and
inserting user interface (UI) elements to style the DOM elements.

14. A system for displaying video content comprising:
a computing device for running a browser;
software for running code;
the browser connecting to a first video content website that receives a user's first authentication data;
the browser connecting to a second video content website that receives a user's second authentication data;
the software storing the first and second authentication data during an initial setup step;
the software receiving a first video stream link from the first website and a second video stream link from the second website without inputting additional authentication data beyond the initial setup step;
a control page presents an aggregation of a first website icon and a second website icon from which the user may select video programming; and
the software transmitting a selected video programming video stream.

15. The system of claim 14 wherein the software is embedded in a microprocessor.

16. The system of claim 15 wherein the microprocessor is embedded in a projector having a light source, an energy source and a lens.

17. The system of claim 14 wherein the computing device and software are embedded within a projector and wherein the projector establishing a connection using a wireless communication media with the projector for transferring setup preferences and for connecting to a networking library.

18. The system of claim 14 wherein the computing device includes a microprocessor that runs a synchronization application for managing multiple types of video streaming platforms.

19. The system of claim 18 wherein the microprocessor runs iOS or Android.

20. The system of claim 14 further comprising a hidden web browser that connects to each streaming platform's website and transmits first user authentication data to a corresponding first video content website and second user authentication data to a corresponding second video content website.
